(19) United States
(12) Patent Application Publication
(10) Pub. No.: US 2024/0326337 A1
(43) Pub. Date: Oct. 3, 2024

(54) RESTORATION OF SURFACE FRICTION COEFFICIENT BY 3D PRINTING

(71) Applicant: International Business Machines Corporation, Armonk, NY (US)

(72) Inventors: Jeremy R. Fox, Georgetown, TX (US); Atul Mene, Morrisville, NC (US); Tushar Agrawal, Wells Fargo, ND (US); Sarbajit K. Rakshit, Kolkata (IN)

(21) Appl. No.: 18/194,696

(22) Filed: Apr. 3, 2023

(51) Int. Cl. B29C 64/386; B29C 64/10; B33Y 10/00; B33Y 50/00

(52) U.S. Cl. CPC B29C 64/386; B29C 64/10; B33Y 10/00; B33Y 50/00

(57) ABSTRACT

An approach for restoring friction level of a surface is disclosed. The approach comprises of utilizing IoT devices, digital twin simulation and 3D printing to actively monitor and adjust surface friction of surfaces, rather than simply applying a passive anti-slip coating. Furthermore, the approach can take into account various factors such as surface inclination, payload movement, and mobility path (via one or more simulations in a digital twin environment) in order to determine the necessary level of surface friction and the appropriate means of restoring it. The approach also allows for the determination of the required surface roughness and the selection of appropriate materials and printing methods in order to achieve it.

### BACKGROUND

The present invention relates generally to coating surfaces and more particularly to applying substance to surfaces to increase friction.

Friction is the force resisting the relative motion of solid surfaces, fluid layers, and material elements sliding against each other. There are several types of friction: i) dry friction, ii) fluid friction, iii) lubricated friction, iv) skin friction and v) internal friction. Dry friction is a force that opposes the relative lateral motion of two solid surfaces in contact. Furthermore, dry friction is subdivided into static friction (“stiction”) between non-moving surfaces, and kinetic friction between moving surfaces. However, except for atomic or molecular friction, dry friction generally arises from the interaction of surface features, known as asperities. Fluid friction describes the friction between layers of a viscous fluid that are moving relative to each other. Lubricated friction is a case of fluid friction where a lubricant fluid separates two solid surfaces. Skin friction is a component of drag, the force resisting the motion of a fluid across the surface of a body. Finally, internal friction is the force resisting motion between the elements making up a solid material while it undergoes deformation.

When surfaces in contact move relative to each other, the friction between the two surfaces converts kinetic energy into thermal energy (that is, it converts work to heat). This property can have dramatic consequences, as illustrated by the use of friction created by rubbing pieces of wood together to start a fire. Kinetic energy is converted to thermal energy whenever motion with friction occurs, for example, when a viscous fluid is stirred. Another important consequence of many types of friction can be wear, which may lead to performance degradation or damage to components. Friction is a component of the science of tribology.

Friction is desirable and important in supplying traction to facilitate motion on land. Most land vehicles rely on friction for acceleration, deceleration and changing direction. Sudden reductions in traction can cause loss of control and accidents.

### SUMMARY

Aspects of the present invention disclose a computer-implemented method, a computer system and computer program product for restoring surface friction. The computer implemented method may be implemented by one or more computer processors and may include, identifying a baseline friction for a surface; determining optimal friction level for the surface; deploying 3D printers to treat the surface; and validating the surface whether it meets the optimal friction level.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating a surface management environment, designated as 100, in accordance with an embodiment of the present invention;

FIG. 2A is a friction coefficient chart as it relates to various surfaces, in accordance with an embodiment of the present invention;

FIG. 2B is a generic diagram illustrating an incline surface with various forces interaction, in accordance with an embodiment of the present invention;

FIG. 3 is a high-level process flow diagram of a particular use case, an industrial floor scenario, illustrating surface management environment 100, in accordance with an embodiment of the present invention;

FIG. 4 is a high-level flowchart illustrating the operation of surface component 111, designated as 400, in accordance with another embodiment of the present invention; and

FIG. 5 depicts a block diagram, designated as 500, of components of a server computer capable of executing the surface component 111 within the surface management environment, of FIG. 1, in accordance with an embodiment of the present invention.

### DETAILED DESCRIPTION

Various surfaces (e.g., walkways, roadways, industrial floor, etc.) can be worn down due to wear and tear from objects moving across those surfaces, wherein the surface friction is reduced. Due to a reduction in surface friction, mobility across these surfaces is reduced and can become dangerous to traverse. Thus, there is a need to correct the level of surface friction between the two surfaces. For example, the surfaces can be a plane surface or inclined surface, or the surfaces may have hazardous conditions, such as, dry, oily etc.

Embodiments of the present invention recognizes the deficiencies in the current state of art as it relates restoring worn down surfaces (i.e., reduced friction) and provides an approach for addressing those deficiencies. For example, current deficiencies in the state of art can include, i) only specifically on monitoring surface contacts, such as robotic wheels or human shoes, to determine if surface friction has reduced and needs correction and ii) using 3D printing to restore surface friction but only printing textures.

The approach comprises of utilizing IoT devices, digital twin simulation and 3D printing to actively monitor and adjust surface friction of surfaces (e.g., inclined surfaces, curves surfaces, etc.), rather than simply applying a passive anti-slip coating. Furthermore, the approach can take into account various factors such as surface inclination, payload movement, and mobility path (via one or more simulations in a digital twin environment) in order to determine the necessary level of surface friction and the appropriate means of restoring it. The approach also allows for the determination of the required surface roughness and the selection of appropriate materials and printing methods in order to achieve it.

The approach can be summarized by the following bulleted points:
1) Surface contact monitoring assessment:
Invention can analyze the IoT feeds from the surface contacts (e.g., robotic wheels, legs, shoes of human workers with surface where they perform mobility) in order to identify if surface friction has reduced and needs correction, and accordingly swarm 3D printer(s) can take appropriate actions to restore the required level on friction between the surface and the wheels, shoes etc.
   a) Determining quantity of friction to be restored:
   Considering point 1, embodiment can, i) analyze surface inclination angle, ii) payloads are to be moved, iii) how the payload can be moved on the surface and accordingly the embodiment can identify how much surface friction is required and accordingly a swarm 3D printers can be directed to restore the required level of surface friction.
   b) Determining mobility path for friction (to be printed):
   Considering point 1, the embodiment can identify the mobility path (i.e., travel path of various objects across the surface), and can be identify the optimum 3D printing-based action to restore the required level of friction for effective mobility around the mobility path.
   c) Determining surface roughness to be achieved:
   Considering point 1, the embodiment can identify the required level of surface roughness, and can identify the appropriate mode of printing, such as, spraying, laying layers etc., and can also select the appropriate materials.
2) Determining the opportune means of 3D printing for desired friction:
The embodiment can identify how the 3D printing-based surface friction correction is to be applied, so that with optimum 3D printing-based correction, the required level of friction can be restored (e.g., 3D printing on the surface where mobility will be performed, wheels which will be running or in both the places etc.).
   a) Robotic application-digital twin simulation:
   Considering point 2, while mobility is required on any surface, the embodiment can be used to perform digital twin simulations in order to identify if surface friction is to be corrected and accordingly the embodiment will identify the appropriate methods to apply different level of surface alteration so that required level of resultant friction is achieved.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

It is noted that the terms, “friction coefficient” and “coefficient of friction” will be used interchangeably and means the same thing. Coefficient of friction is a ratio of the frictional force resisting the motion of two surfaces that are in contact to the normal force pressing the two surfaces together. Typically, the coefficient is symbolized by the Greek letter mu (u).

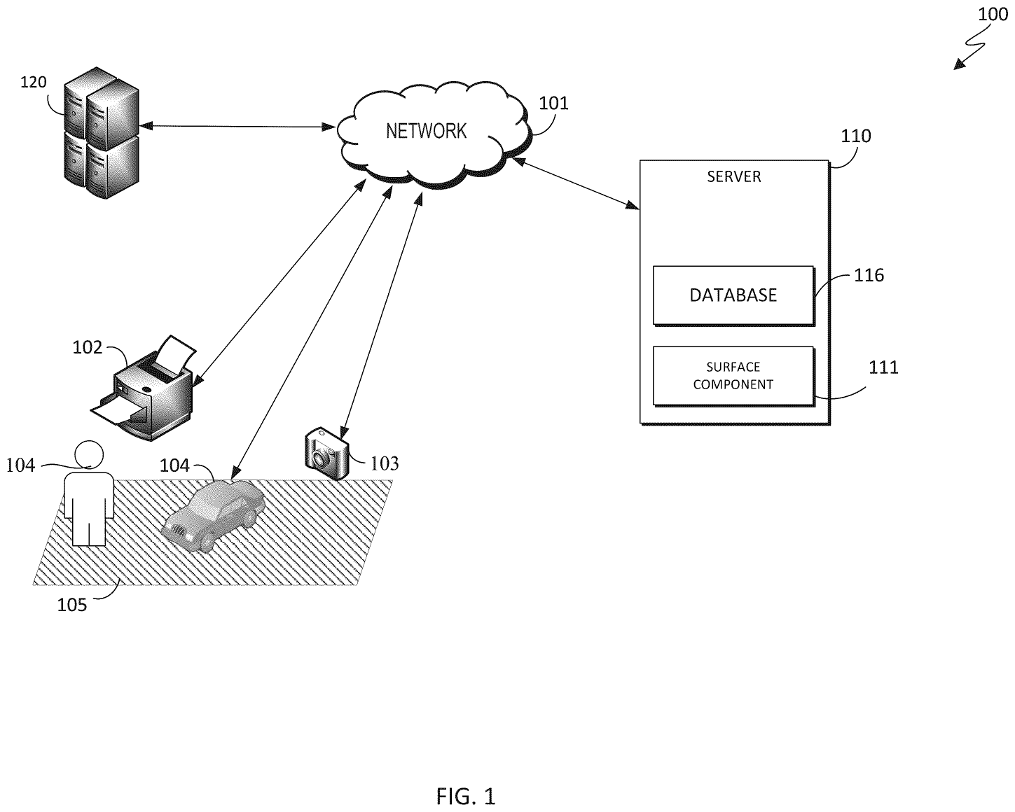

FIG. 1 is a functional block diagram illustrating a surface management environment, designated as 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Surface management environment 100 includes network 101, 3D printers 102, IoT (Internet of Things) devices 103, moving objects 104, surfaces 105, server 110 and digital twin server 120.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110 and other computing devices (not shown) within surface management environment 100. It is noted that other computing devices can include, but are not limited to, any electromechanical devices capable of carrying out a series of computing instructions.

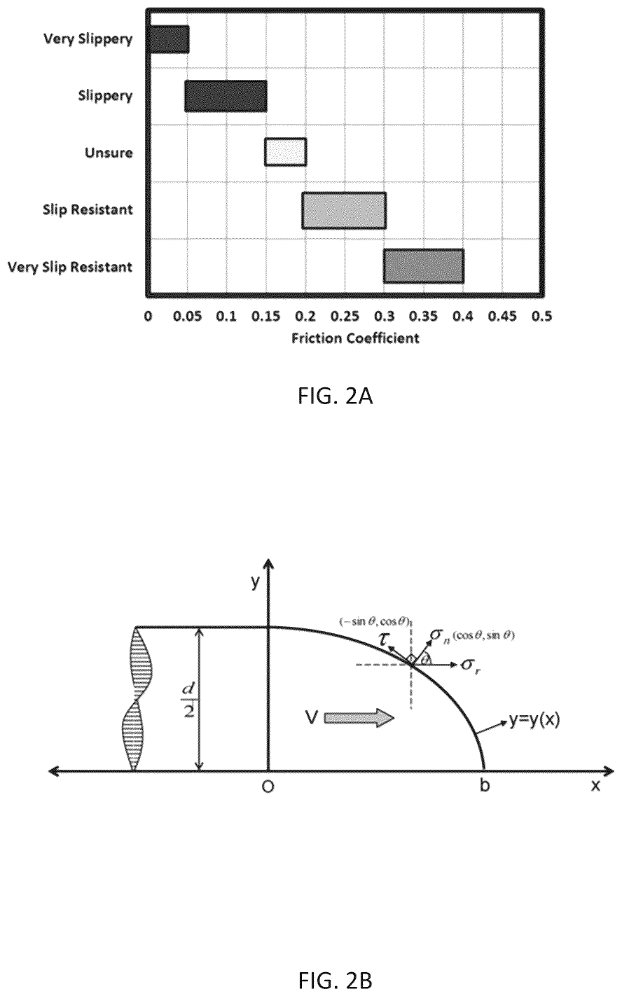

3D printers 102 are mechanic devices that can propel itself from one location to another based on received instructions. 3D printers 102 also have the capability of “printing” or “delivering” various materials to either smooth out crevices on a surface or can add friction to the surface. Furthermore, 3D printers 102 includes various sensors (e.g., proximity, camera with object identification, etc.) to help it navigate and measure the floor friction coefficient. For example, in an industrial floor environment that is frequent by wheel machines and/or humans to transport various materials during manufacturing (e.g., moving raw products to machine, removing finished products from the machine, etc.), the surface of the industrial floor is marred with pits, holes, and groves due to heavy use. Furthermore, in addition to the imperfection of the surface, the friction coefficient may be lessened as well (i.e., becomes more slippery). Therefore, 3D printers 102 (either one or a swarm of printers) can quickly move to fix the floor imperfection by printing materials to level the grooves and holes. As previously mentioned, 3D printers 102 can also print materials to add more friction to the surface (see FIG. 2A for numerical equivalency of “slippery” to “very slip resistant”. It is noted that there are existing materials (various polymer compounds delivered in semi-liquid state or liquid state) that can add more friction to a surface to make it “slip resistant”. These compounds solidify after a certain amount of time when exposed to air.

In another embodiment of 3D printers 102, it can contain IoT devices and the capability of making either group or individual decisions to automatically fix imperfection to floor surfaces (i.e., surfaces 105) and/or make those surfaces becomes more slip resistance. This embodiment would leverage the “hive mentality” of animals, such as bees, wasps and ants where the workers would autonomously or as a group repair broken nest walls and other necessary parts crucial to the survival of the colony.

IoT devices 103 are computerized objects (or groups of such objects) with sensors that have the capability to connect and exchange data with other devices and systems over a network (e.g., internet, private network, etc.). For example, an IoT devices can include, but it is not limited to, video cameras, sound measurement devices, thermal IR (infrared) cameras and drones.

Moving objects 104 are either living or non-living objects that travel over surfaces 105. Surfaces 105 are surfaces (e.g., industrial factory floor, office/retail floors, residence floor, garage surfaces, roadway surfaces, airport runways, etc.) that the friction coefficient has lessened to a point (i.e., very slippery) where moving objects 104 traversing the surfaces may become difficult or even hazardous. Living objects can be, but not limited to humans (e.g., industrial workers, passengers, etc.), animals, etc. and non-living objects can be, but not limited to wheel machines (i.e., carts for transporting raw materials or finished goods) or machines with tank-like treads as a means of locomotion. Essentially, moving objects 104 can be any object that has to traverse surfaces 105 by means of physical contact (e.g., walking, sliding/slithering, spinning wheel, etc.).

Server 110 or digital twin server 120 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 or digital twin server 120 can be a laptop computer, a tablet computer, a netbook computer, a personal computer (PC), a desktop computer, a personal digital assistant (PDA), a smart phone, or any other programmable electronic device capable of communicating with other computing devices (not shown) within surface management environment 100 via network 101. In another embodiment, server 110 or digital twin server 120 represents a computing system utilizing clustered computers and components (e.g., database server computers, application server computers, etc.) that act as a single pool of seamless resources when accessed within surface management environment 100.

Digital twin server 120 are servers that house digital twin computing application and software. Generally, digital twin computing leverage IoT, artificial intelligence (i.e., leveraging machine/deep learning) and software analytics to create living digital simulation models that update and change as their physical counterparts change. A digital twin continuously learns and updates itself to represent its near real-time status. A digital twin also integrates historical data from past usage to factor into its digital model. What is a simulation? A simulation is an approximation of a process and/or a system (e.g., machines, etc.). Furthermore, simulations are run in virtual environments that may be representations of physical environments but do not integrate real-time data (i.e., used by digital twin computing). The main difference between a simulation (and/or modeling) versus a digital twin is that a digital twin can use real-time data based on the regular transfer of information between the digital twin and its corresponding physical environment.

Specifically to this present embodiment, digital twin server 120 is used to model surfaces for, but is not limited to industrial floor application, roadways and airport runways. For an example in an industrial floor application, there are IoT sensors that can continuously update the digital twin in the simulation with real time data.

Embodiment of the present invention can reside on server 110, digital twin server 120 or 3D printer 102. Server 110 includes surface component 111 and database 116.

Surface component 111 provides the following capabilities; i) measure the current friction state (i.e., friction coefficient or coefficient of friction) of a floor, surface ii) periodically measure the baseline friction of the floor surface, iii) initiate a digital twin simulation for friction deployment, iv) select target area identified through heat-mapping, v) determine materials to be utilized for friction based 3D printing, vi) deploy 3D printers to the identified target area and vii) monitor same area over time for future reprinting.

The seven capabilities mentioned in the preceding paragraphs as it relates to surface component 111 are explain in further details in subsequent paragraphs:

### Measuring the Current Friction State

Embodiment can capture (via IoT devices) surface friction between surface and moving objects. Therefore, embodiment will measure a baseline (i.e., starting time) of the coefficient friction of the surface at some initial time (ti). As it can be seen from FIG. 2B (i.e., diagram of inclined surface) that friction decreases over time based on variables, such as, usage, wear and time of use. It can be deduced that the coefficient friction will decrease, as usage remains constant over time.

There are various factors that can affect the coefficient of friction for two surfaces in relative motions. These factors are:
Surface Finish—The number, roughness and even the directional contact points of the asperities on the surfaces can dramatically affect the frictional coefficient.
Temperature—Both ambient and operational temperature can affect friction. For example, temperature is a critical element in whether an anti-wear or extreme pressure additive will be effective in certain applications.
Operational Load—Friction varies directly with load. A load exceeding the designed capacity will dramatically increase the frictional coefficient.
Relative Speed—Increasing the speed beyond that which is safely specified will dramatically increase friction.
Nature of the Relative Motion between the Surfaces—Sliding motion versus rolling motion can affect the coefficient of friction.

### Measuring Frequency of the Baseline Friction

Embodiment determines how often the surface friction data should be measured. These measurements can be collected periodically based on the expected floor usage. For example, for high floor usage, the data on friction should be collected daily (i.e., 24 hours). Monitoring for any slipping points, excessive floor wear on common path(s) utilized by a large number of machines. Given the “always on” 24-hour operation, Monitoring frequency would be daily and be sent for recognizance and measuring during lulls within the shift activity for that particular day. In another example, for medium floor usage that has daily usage but less track on certain days of the week or standard 8-hour shifts for medium size set of robotic usage (i.e., industrial floor environment) then embodiment can monitor weekly and sent off for recognizance and measuring off-shift. In another example, for a low floor usage scenario, this means that the floor has limited usage, such as, to only certain days of the week or limited to a small set of robotic usage (i.e., industrial floor environment). In the preceding scenario, the embodiment can monitor the floor on a monthly or bi-monthly basis.

### Initiating a Digital Twin Simulation

Embodiment can perform various simulation scenarios (e.g., to determine friction type and thresholds on restoring surface friction, etc.) based on the data from IoT and other sources (e.g., database 116, etc.) on the digital twin server 120. Other simulation scenarios can include, but it is not limited to, i) estimating duration of time to restore the friction of the target level of performance of moving objects 104 on surfaces 105 where there is a high rate of success to remove common slippage (i.e., increase friction coefficient) and ii) simulation on the amount of friction and/or type of materials to be printed/deployed onto the surface.

Other simulations can include restoring holes, pits, grooves and imperfections to the surfaces not relating to friction.

### Selecting Target Area

Embodiment can analyze if certain sections of the floor surfaces require more attention than other places through the use of heat-maps. Heat-maps can be 2D or 3D graphs showing surface area (i.e., maps) of a surface wherein the “heat” (any sort of color and/or shape designation) appears on the map to illustrate an aggregated or accumulated movement (e.g., footprints, wheel marks, etc.) over time for that given surface.

### Determining Materials for 3D Printing

Embodiment has determined the amount of friction required to be added to the surface (from digital twin simulation scenarios) or amount of floor material to fix imperfections on the surface. The next step is for embodiment to determine what type of materials is best suited for the particular floor. If the floor is made from concrete, then a concrete mix would be used to repair imperfections. Furthermore, an adhesive layer could be applied on top of the concrete to increase the coefficient of friction.

### Deploying 3D Printers

Depending on the size of the imperfections and locations, embodiments can send one or multiple 3D printers to restore the surface (i.e., swarms of 3D printers). Sensors onboard 3D printers can validate if the desired level of coefficient of friction has been achieved or the imperfection has been restored to its original/initial state.

### Monitoring Same Area Over Time

Embodiment can continually monitor the recently treated surface to ensure that the coefficient friction is maintained at the desired level.

Database 116 is a repository for data used by surface component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within surface management environment 100, provided that surface component 111 has access to database 116. Database 116 may store information associated with, but is not limited to, dry friction, fluid friction, lubricated friction, skin friction, internal friction, 3D printers model and specifications, materials used by 3D printers, IoT model and specifications, training data for digital twin simulation, weather data, traffic data, models of coefficient friction as it related to various floor surfaces, mobility pattern of humans and robotic transport, heatmapping for various surfaces, mathematical formulas (e.g., friction coefficient, etc.) relating to forces applied to an object as the object moves across a surface.

FIG. 2A is a friction coefficient chart as it relates to various surfaces, in accordance with an embodiment of the present invention. The X-axis of the chart denotes coefficient of friction from zero to 0.5. The Y-axis of the chart denotes real-world interpretation as labels (e.g., “very slippery”, “unsure”, “very slip resistant”, etc.) of degrees of “slipperiness” all the way to the most slip resistant.

FIG. 2B is a basic diagram illustrating an incline surface with various forces. The basic diagram illustrates an object's interaction with an inclined surface, wherein that object is rolling and/or sliding. If the friction between the object and the surface is less, then the object will slide. Consequently, if the friction is more, then the object will not slide or will slide slowly. The diagram (i.e., graph) also shows the force component (i.e., as arrows). For example, if the object does not move, then frictional force is more or equal to the downwards force.

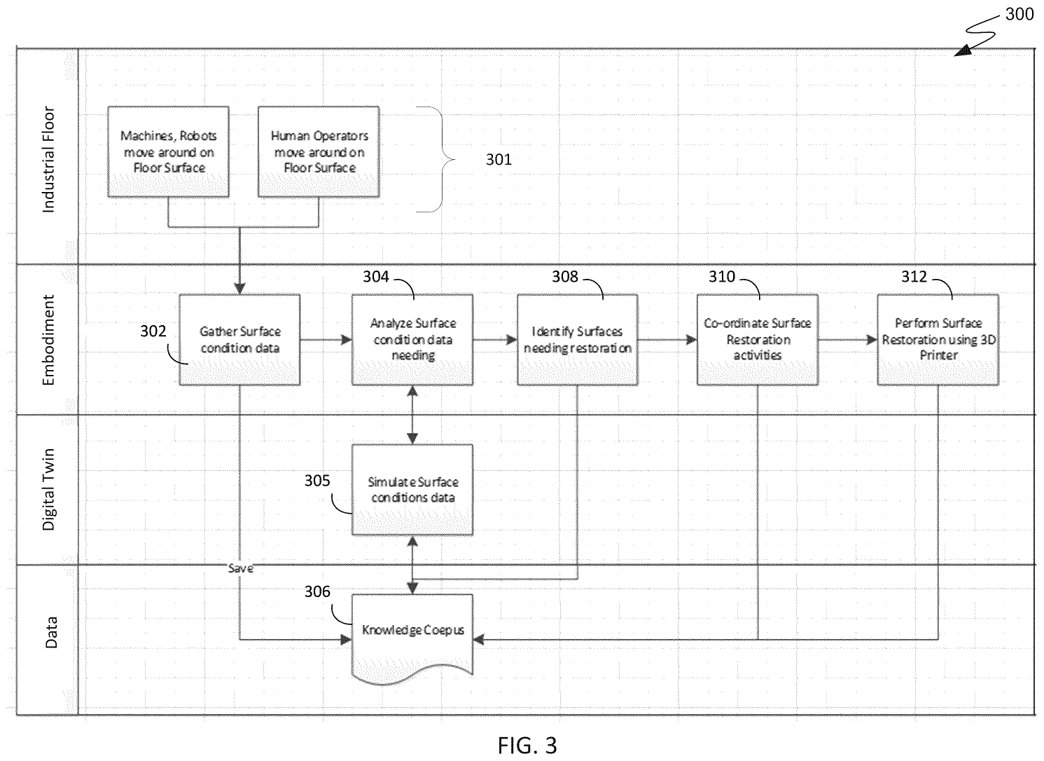

FIG. 3 is a high-level process flow diagram illustrating a use case scenario of surface component 111 for an industrial floor application, designated as process 300, in accordance with another embodiment of the present invention. The main components heading (shown on the left-hand side) includes data, digital twin, embodiment, and industrial floor. The industrial floor (301) is main target to be observed and coefficient of the floors to be maintained to a desired level that conforms to safety and efficiency. It can be shown that data gathering (302) of industrial floor (301) occurs as the first step. Then all the subsequent steps follow: i) analyzing surface condition 304, ii) simulating with digital twin 305 with data from 301 and corpus of knowledge 306 (i.e. database 116), iii) identifying surfaces for restoration (308), iv) coordinating surface restoration (310) and v) finally to perform surface restoration using 3D printers (312).

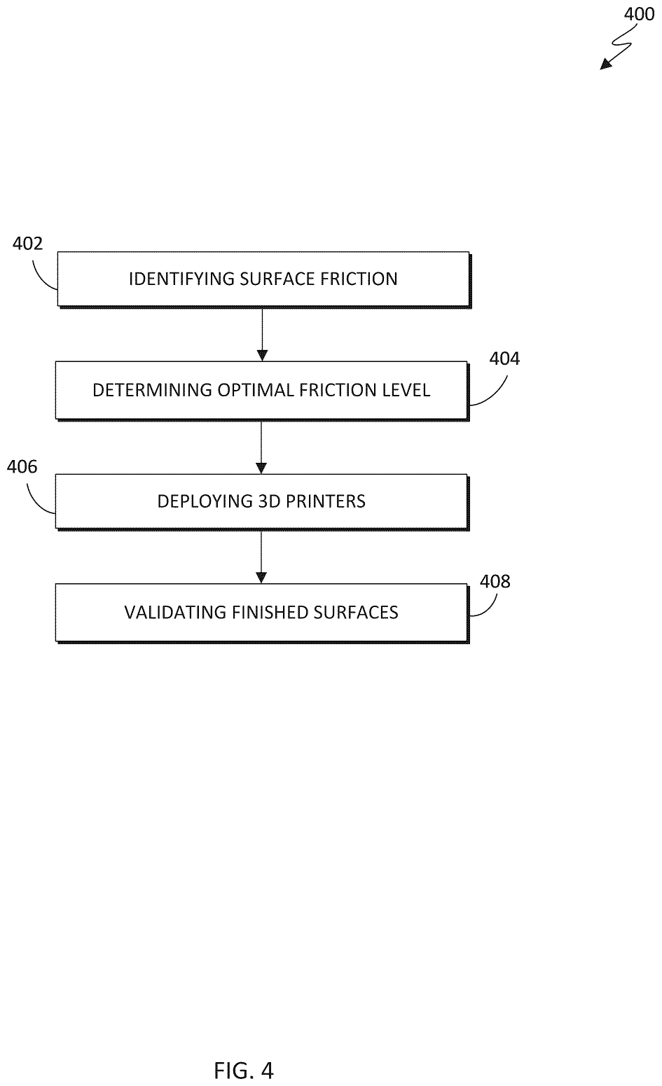

FIG. 4 is a high-level flowchart illustrating the operation of surface component 111, designated as process 400, in accordance with yet another embodiment of the present invention.

In an embodiment, surface component 111 identifies surface friction (step 402) of surfaces 105. Generally, surface component 111 can leverage IoT devices and/or 3D printers to measure and/or observe the level of friction of a particular surface of interest. A use case scenario (i.e., known as “example_1”) of an industrial floor will be used to illustrate the high-level steps. The industrial floor (one section of large manufacturing facility) has an area of 100 meters by 50 meters. This particular floor space is primarily used as a corridor to transport materials from one area to another. The surface is made from concrete material with a smooth finish. The corridor is frequented by robotic devices that transport materials as well as human workers who use forklifts and pedestrian foot traffic (office workers to go from one side of the building to the cafeteria). For example, surface component 111, can receive data (i.e., surface data) from IoT devices 103 to measure/observe a baseline level of friction for the industrial floor corridor.

In the embodiment, surface component 111 determines the optimal level of friction required for surfaces 105 (step 404). Referring back to our uses case scenario (i.e., example_1) of the industrial floor, surface component 111 has concluded that the current surface condition is too slippery since the coefficient of friction is 0.05 (see FIG. 2A) and the corridor surface must be treated. Surface component 111 can simulate various scenarios within the digital twin environment (via digital twin server 120) to determine the optimal level of 0.2 coefficient of friction (i.e., more slip resistance/coefficient of friction) to allow travel by robots, forklifts and pedestrians to continue. Furthermore, having determined that a desired level of 0.2 coefficient of friction is required, surface component 111 determines what type of material (i.e., slip resistance epoxy) is needed to achieve that level.

In another embodiment, using another use case scenario (i.e., known as “example_2”) similar to the example_1. Example_2 has the same facts as example_1 but the floors have deeper grooves and holes. Thus, surface component 111 must repair the flooring surface before treating the actual surface with anti-slip materials.

In the embodiment, surface component 111 deploys the 3D printers (step 406) to the surface. Referring back to our uses case scenario (i.e., example_1) of the industrial floor, surface component 111 deploys several 3D printers to restore coefficient of friction by printing an epoxy like material onto the floor. It is noted that it is possible that 3D printers may not always have the ideal printing materials in stock/on board and 3D printers may mobilized towards an inventory area to retrieve and be equipped with the correct printing materials before moving to its final destination.

In another embodiment, referring to example_2, 3D printers would first need to treat the deep holes and grooves by printing similar materials to fill the holes and grooves before deploying an anti-slip coating. Thus, one 3D printer may have the necessary materials (i.e., concrete like) to fill the gap while a second 3D printer (instructed to work in conjunction) has only the materials (i.e., epoxy) for anti-slip resistance.

In the embodiment, surface component 111 validates the surface (step 408). Surface component 111 validates the treated surface has achieved the desired level of coefficient of friction. Referring back to our use case scenario (i.e., example_1) of the industrial floor, surface component 111, through IoT devices or sensors on 3D printers verifies the level of coefficient of friction has reached the target level of 0.2.

Furthermore, surface component 111 can continually monitor the same surface based on how often it is used (i.e., surface frequency period). For example, given the “always on” 24-hour operation, monitoring frequency would be daily and be sent for recognizance and measuring during lulls within the shift activity for that particular day. In another example, for medium floor usage that has daily usage but less track on certain days of the week or a standard 8-hour shift for medium size set of robotic usage (i.e., industrial floor environment) then embodiment can monitor weekly and sent off for recognizance and measuring off-shift. In another example, for low floor usage where it has limited usage only to certain days of the week or limited to small set of robotic usage (i.e., industrial floor environment) then embodiment can monitor to monthly or bi-monthly.

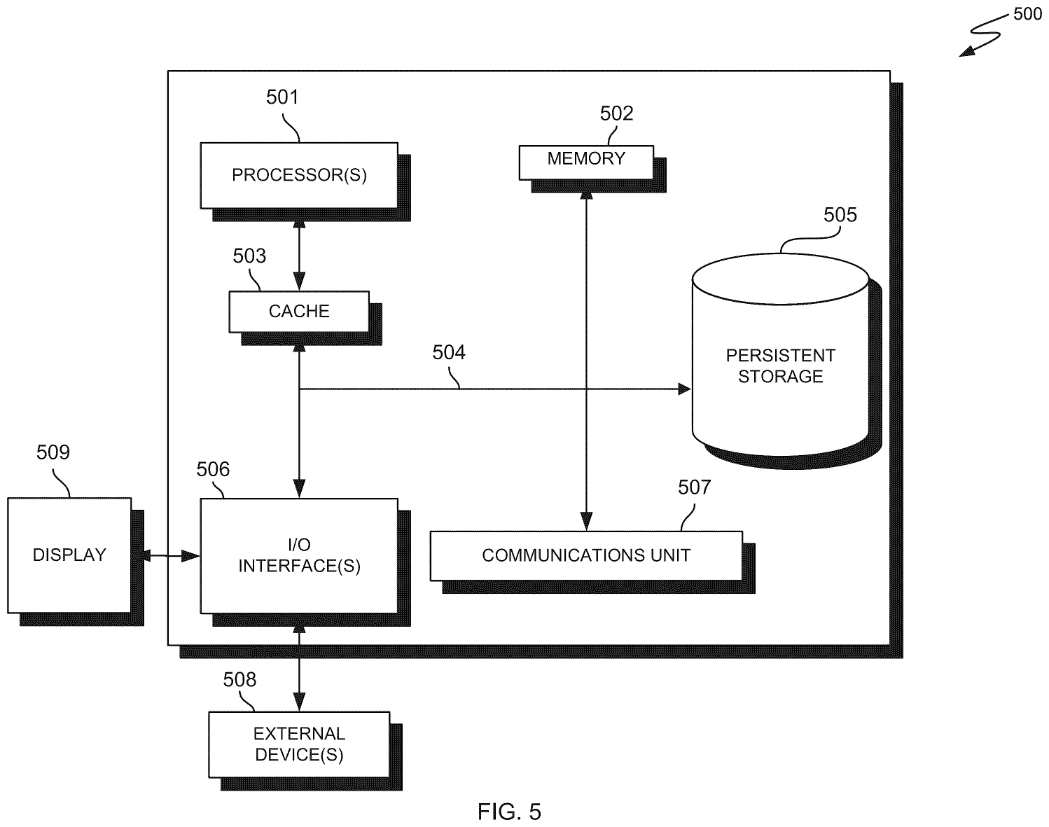

FIG. 5, designated as 500, depicts a block diagram of components of surface component 111 application, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

FIG. 5 includes processor(s) 501, cache 503, memory 502, persistent storage 505, communications unit 507, input/output (I/O) interface(s) 506, and communications fabric 504. Communications fabric 504 provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of processor(s) 501 by holding recently accessed data, and data near recently accessed data, from memory 502.

Program instructions and data (e.g., software and data×10) used to practice embodiments of the present invention may be stored in persistent storage 505 and in memory 502 for execution by one or more of the respective processor(s) 501 via cache 503. In an embodiment, persistent storage 505 includes a magnetic hard disk drive. Alternatively, or in addition to a magnetic hard disk drive, persistent storage 505 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505. Surface component 111 can be stored in persistent storage 505 for access and/or execution by one or more of the respective processor(s) 501 via cache 503.

Communications unit 507, in these examples, provides for communications with other data processing systems or devices. In these examples, communications unit 507 includes one or more network interface cards. Communications unit 507 may provide communications through the use of either or both physical and wireless communications links. Program instructions and data (e.g., surface component 111) used to practice embodiments of the present invention may be downloaded to persistent storage 505 through communications unit 507.

I/O interface(s) 506 allows for input and output of data with other devices that may be connected to each computer system. For example, I/O interface(s) 506 may provide a connection to external device(s) 508, such as a keyboard, a keypad, a touch screen, and/or some other suitable input device. External device(s) 508 can also include portable computer readable storage media, such as, for example, thumb drives, portable optical or magnetic disks, and memory cards. Program instructions and data (e.g., surface component 111) used to practice embodiments of the present invention can be stored on such portable computer readable storage media and can be loaded onto persistent storage 505 via I/O interface(s) 506. I/O interface(s) 506 also connect to display 509.

Display 509 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for restoring friction level of a surface, comprising:
identifying a baseline friction for a surface;
determining optimal friction level for the surface;
deploying 3D printers to treat the surface; and
validating the surface whether it meets the optimal friction level.

2. The method of claim 1, wherein identifying the baseline friction further comprising:
receiving a first plurality of surface data from IoT devices based on a surface frequency period, wherein the surface frequency period can be categorized as “always on”, “medium” and “low” usage and wherein the first plurality of surface data comprise of the first friction coefficient of the surface at an initial time.

3. The method of claim 1, wherein determining the optimal friction level further comprising:
creating one or more digital twin simulation scenarios associated with the surface based on a plurality of surface data;
initiating the one or more digital twin simulation scenarios; and
outputting one or more optimal friction level based on the result of the digital twin simulation.

4. The method of claim 1, wherein deploying 3D printers to treat the surface further comprising:
instructing one or more 3D printers with one or more locations to move towards and selecting one or more printer materials to be utilized at the one more locations; and
printing the one or more printer materials at the one or more locations.

5. The method of claim 1, wherein validating the surface further comprising:
measuring a second plurality of surface data from IoT devices and/or 3D printers;
determining whether the second friction coefficient is the same as the one or more optimal friction level; and
continuously measure the surface based on a surface frequency period.

6. The method of claim 1, wherein the one or more digital twin simulation scenarios further comprises, estimating duration of time to restore friction of target level, amount and/or types to be printed onto the surface and restoring surface imperfections not related to friction.

7. The method of claim 1, wherein the surfaces further comprise industrial factory floor, roadway surfaces, office/retail floor, residence floor, garage surfaces and airport runways.

8. A computer program product for restoring friction level of a surface, the computer program product comprising:
one or more computer readable storage media having computer-readable program instructions stored on the one or more computer readable storage media, said program instructions executes a computer-implemented method comprising steps of:
identifying a baseline friction for a surface;
determining optimal friction level for the surface;
deploying 3D printers to treat the surface; and
validating the surface whether it meets the optimal friction level.

9. The computer program product of claim 8, wherein identifying the baseline friction further comprising:
receiving a first plurality of surface data from IoT devices based on a surface frequency period, wherein the surface frequency period can be categorized as “always on”, “medium” and “low” usage and wherein the first plurality of surface data comprise of the first friction coefficient of the surface at an initial time.

10. The computer program product of claim 8, wherein determining the optimal friction level further comprising:
creating one or more digital twin simulation scenarios associated with the surface based on a plurality of surface data;
initiating the one or more digital twin simulation scenarios; and
outputting one or more optimal friction level based on the result of the digital twin simulation.

11. The computer program product of claim 8, wherein deploying 3D printers to treat the surface further comprising:
instructing one or more 3D printers with one or more locations to move towards and selecting one or more printer materials to be utilized at the one more locations; and
printing the one or more printer materials at the one or more locations.

12. The computer program product of claim 8, wherein validating the surface further comprising:
measuring a second plurality of surface data from IoT devices and/or 3D printers;
determining whether the second friction coefficient is the same as the one or more optimal friction level; and
continuously measure the surface based on a surface frequency period.

13. The computer program product of claim 8, wherein the one or more digital twin simulation scenarios further comprises, estimating duration of time to restore friction of target level, amount and/or types to be printed onto the surface and restoring surface imperfections not related to friction.

14. The computer program product of claim 8, wherein the surfaces further comprise industrial factory floor, roadway surfaces, office/retail floor, residence floor, garage surfaces and airport runways.

15. A computer system for restoring friction level of a surface, the computer system comprising:
one or more computer processors;
one or more computer readable storage media; and
one or more computer readable storage media having computer-readable program instructions stored on the one or more computer readable storage media, said program instructions executes a computer-implemented method comprising steps of:
identifying a baseline friction for a surface;
determining optimal friction level for the surface;
deploying 3D printers to treat the surface; and
validating the surface whether it meets the optimal friction level.

16. The computer system of claim 15, wherein identifying the baseline friction further comprising:
receiving a first plurality of surface data from IoT devices based on a surface frequency period, wherein the surface frequency period can be categorized as “always on”, “medium” and “low” usage and wherein the first plurality of surface data comprise of the first friction coefficient of the surface at an initial time.

17. The computer system of claim 15, wherein determining the optimal friction level further comprising:
creating one or more digital twin simulation scenarios associated with the surface based on a plurality of surface data;
initiating the one or more digital twin simulation scenarios; and
outputting one or more optimal friction level based on the result of the digital twin simulation.

18. The computer system of claim 15, wherein deploying 3D printers to treat the surface further comprising:
instructing one or more 3D printers with one or more locations to move towards and selecting one or more printer materials to be utilized at the one more locations; and
printing the one or more printer materials at the one or more locations.

19. The computer system of claim 15, wherein validating the surface further comprising:
measuring a second plurality of surface data from IoT devices and/or 3D printers;
determining whether the second friction coefficient is the same as the one or more optimal friction level; and
continuously measure the surface based on a surface frequency period.

20. The computer system of claim 15, wherein the one or more digital twin simulation scenarios further comprises, estimating duration of time to restore friction of target level, amount and/or types to be printed onto the surface and restoring surface imperfections not related to friction.
